(19) United States
(12) Patent Application Publication
(10) Pub. No.: US 2024/0059507 A1
(43) Pub. Date: Feb. 22, 2024

(54) Underground container logistics loading and unloading system based on deep underground passage

(71) Applicant: Shanghai Maritime University, Shanghai (CN)

(72) Inventors: Chengji Liang, Shanghai (CN); Xiaoyuan Hu, Shanghai (CN); Daofang Chang, Shanghai (CN); Yu Wang, Shanghai (CN); Yue Zhang, Shanghai (CN); Yuting Zhang, Shanghai (CN); Yinping Gao, Shanghai (CN); Houjun Lu, Shanghai (CN); Yang Pan, Shanghai (CN)

(73) Assignee: Shanghai Maritime University, Shanghai (CN)

(21) Appl. No.: 18/269,594

(22) PCT Filed: Apr. 22, 2022
(86) PCT No.: PCT/CN2022/000070

§ 371 Date: Jun. 26, 2023

(30) Foreign Application Priority Data
Apr. 25, 2021 (CN) CN202110445454.X

(51) Int. Cl. B65G 63/00; B65G 69/00

(52) U.S. Cl. CPC B65G 63/004; B65G 69/001; B66C 17/20

(57) ABSTRACT

The invention provides an underground container logistics loading and unloading system based on a deep underground passage. The underground container logistics loading and unloading system comprises an automatic container wharf, a logistics park and the deep underground passage. The automatic container wharf is connected with the logistics park through the deep underground passage, and the deep underground passage internally comprises an area where shuttle vehicles run; and the deep underground passage comprises a main body layout area and accessory equipment. By applying the embodiment of the invention, through a vertical loading and unloading mode and an underground container logistics transportation mode, cargo transportation is realized, and transportation of ground container trucks is shunted to a certain extent, so that the ground transportation pressure of a port city is relieved, the transportation distance between the container wharf and the out-of-city logistics park is shortened, and the transportation efficiency of port collection and distribution and the safety in the transportation process are effectively improved.

### CROSS-REFERENCE TO RELATED APPLICATION

The subject application is a continuation-in-part of PCT/CN2022/000070 filed on Apr. 22, 2022, which claims priority on Chinese patent application CN113135438A filed on Jul. 20, 2021, in China. The contents and subject matter of the PCT international application and Chinese priority application are incorporated herein by reference.

### FIELD OF INVENTION

The present invention relates to the technical field of underground passage transportation, and relates in particular to an underground container logistics loading and unloading system and transporting method for the same.

### BACKGROUND ART

Underground container logistics system is characterized by its underground transportation mode of full automation and efficiency. At present, although there are some theoretical studies on the underground container logistics system and the development and utilization of underground passage, there is still a lack of vertical loading and unloading for connecting the transportation on the ground and in a deep underground passage using automation technologies.

Guo¹ discloses a method of underground container transport in a general sense, and does not give a specific scheme for applying the transport method. The method only gives the container loading and unloading, but the specific how to load and unload and what kind of equipment to use is not given. The method only gives the tunnel or underground pipeline, but does not give the layout of the loading and unloading area and the layout in the channel.

Chang² discloses a layout of logistics parks that can use underground logistics for transportation. However, it does not deal with the specific layout and transportation mode design within the underground corridor.

Gao³ discloses a surface system layout that interfaces with the underground logistics system. However, it does not involve underground transport.

### SUMMARY OF THE INVENTION

In contrast to the prior art for underground logistics systems, the invention creatively proposes an underground container logistics loading and unloading mode based on deep passage, designs a deep underground transport mode for long-distance transport scenarios, and proposes a transport vehicle scheduling algorithm for this mode, solving the problem of automated transport between automated container terminals and inland areas throughout.

The underground container logistics loading and unloading system based on the deep underground passage of the present invention comprises an automatic container terminal, a logistics park, and a deep underground passage.

The deep underground passage connects the automatic container terminal with the logistics park.

The deep underground passage comprises a main layout zone and an accessory equipment.

The main layout zone comprises an underground work area, a front buffer zone, a back buffer zone, a multitude of maintenance tracks, a first turnback zone, a second turnback zone, eight slope buffer zones, and eight slopes.

The underground work area is below a first shaft mouth.

The front buffer zone is a preset distance from the underground work area to be employed for the parking of the multitude of shuttle vehicles and the front buffer zone comprises a multitude of tracks for the multitude of shuttle vehicles to wait for unloading operation and wait to enter the deep underground passage.

The first turnback zone is located on one side of the underground work area for the multitude of shuttle vehicles to turnback.

The second turnback zone is located on one side of the underground work area for the multitude of shuttle vehicles to turnback or in case of emergency.

The back buffer zone is located behind the first turnback zone and the second turnback zone for the multitude of shuttle vehicles for the parking of.

The multitude of maintenance tracks are located in the back buffer zone.

The slopes are located on both sides of the deep underground passage, with four to the left and four to the right.

The slope buffer zones are located at the slopes for the multitude of shuttle vehicles for the parking of temporarily.

The accessory equipment comprises a multitude of charging piles, the multitude of tracks, two drainage ditches, two blind ditches, a fire-fighting equipment, a ventilation device, a lighting device, and an emergency communication device.

The multitude of tracks are located on the ground of the deep underground passage.

The multitude of charging piles are located on the multitude of tracks.

The fire-fighting equipment and the emergency communication device is on wall of the deep underground passage.

The ventilation device is located at a top of the deep underground passage.

The lighting device is located on the top of the deep underground passage.

The drainage ditches are located at both ends of the deep underground passage ground.

The blind ditches are located at both ends of the deep underground passage ground.

The automatic container terminal comprises the first shaft mouth, a ground working area, a multitude of AGV operation lanes, a multitude of AGV running lanes, a berth, a terminal front, a terminal yard, a container freight station, a terminal parking lot.

The first shaft mouth is a node connecting a ground and the deep underground passage.

The ground work area is employed to load and unload the multitude of the AGVs in the first shaft mouth.

The multitude of AGV operation lanes are located on both sides of the first shaft mouth for the multitude of the AGVs to load and unload.

The multitude of AGV running lanes are located on both sides of the first shaft mouth for the multitude of the AGVs to transport.

The berth is employed to berth and operate a multitude of container vessels.

The terminal yard is management zone for the multitude of containers.

The container freight station is employed to pack and unpack the multitude of containers.

The terminal parking lot is employed for the parking of the container trucks in the automatic container terminal.

The multitude of three-beam fixed cranes are located above the first shaft mouth for loading and unloading of the multitude of the AGVs and the multitude of shuttle vehicles.

A multitude of coast cranes are employed to load and unload the container vessels.

A multitude of the multitude of automatic stacking cranes are employed to load, unload and stack the multitude of containers.

The container trucks are employed to transport the multitude of containers.

The multitude of the AGVs are employed to transport the multitude of containers between the terminal yard and the multitude of coast cranes.

In one realization mode, the logistics park comprises a second shaft mouth, a ground operation zone, the multitude of AGV operation lanes, the multitude of AGV running lanes, a warehouse, a sorting zone, a distribution zone, a park yard, a park ground cargo loading and unloading zone, a no-load AGV waiting zone.

The second shaft mouth is located on the side of the park yard and is a vertical loading/unloading connection between the logistics park and the deep underground passage.

The ground work area is employed to load and unload the multitude of the AGVs in the second shaft mouth.

The multitude of AGV operation lanes are located on both sides of the second shaft mouth for the multitude of the AGVs to load and unload.

The multitude of AGV running lanes are located on both sides of the second shaft mouth for the multitude of the AGVs to transport.

The no-load AGV waiting zone near the second shaft mouth.

The park yard is located near the second shaft mouth for the multitude of containers in the logistics park to hand, stack and store.

The park ground cargo loading and unloading zone is employed to load and unload the multitude of containers transported by container trucks.

The warehouse is located on one side of the ground cargo loading and unloading zone.

The sorting zone is located on one side of the warehouse.

The distribution zone is located on one side of the warehouse.

The deep underground passage is a two-way driveway.

Compared with the prior art, the present invention brings the subsequent technical effects:

The purpose of the present invention is to provide the underground container logistics loading and unloading system based on deep underground passage for vertical loading and transportation in the form of underground container logistics to transport goods in container trucks. On this basis, a model for joint scheduling of the multitude of the AGVs, shuttle vehicles, and the multitude of three-beam fixed cranes in the loading and unloading process of the underground logistics system for the multitude of containers is established. The multitude of shuttle vehicles have a given marshaling policy and leaving frequency. The present invention diverts the container trucks transport, thus relieving the ground transport pressure in the port city, shortening the transport distance between the container terminal and the out-of-town logistics park, effectively improving the efficiency of port consolidation and transport and the safety of the transport process, while playing a role in relieving ground traffic congestion and reducing the environmental pollution.

### BRIEF DESCRIPTION OF DRAWINGS

FIG. 1 is a plane flow diagram of the underground container logistics loading and unloading mode based on the deep passage in an embodiment of the present invention.

FIG. 2 is the A-A section of the first shaft mouth and the second shaft mouth of the present invention.

FIG. 3 is the A-A section of the deep underground passage of the present invention.

FIG. 4 is an underground B-B section of the first shaft mouth and the second shaft mouth of the present invention.

FIG. 5 is the overall A-A section of the deep underground passage of the present invention.

FIG. 6 is the B-B section of the deep underground passage of the present invention.

FIG. 7 is a flow chart of the loading and unloading operation using the first shaft mouth and the second shaft mouth.

FIG. 8 is a flow chart of the loading and unloading operation using the first shaft mouth and the second shaft mouth.

FIG. 9 is the genetic algorithm flow chart.

The reference signs of the drawings are as follows: 1 stands for automatic container terminal; 2 stands for logistics park; 3 stands for deep underground passage; 4 stands for container; 5 stands for first shaft mouth; 6 stands for ground work area; 7 stands for AGV operation lanes; 8 stands for AGV running lanes; 9 stands for berth; 10 stands for terminal front; 11 stands for terminal yard; 12 stands for terminal office building; 13 stands for maintenance room; 14 stands for container freight station; 15 stands for terminal parking lot; 16 stands for terminal gate; 17 stands for three-beam fixed crane; 18 stands for slideway; 19 stands for beam; 20 stands for fixed crane lighting device; 21 stands for column; 22 stands for fixed groove; 23. stands for chain; 24 stands for motor; 25. stands for transmission wheel set; 26 stands for coast crane; 27 stands for automatic stacking crane; 28 stands for container truck; 29 stands for AGV; 30 stands for warehouse; 31 stands for sorting zone; 32 stands for distribution zone; 33 stands for dispatching center; 34 stands for parking; 35 stands for park yard; 36 stands for park ground cargo loading and unloading zone; 37 stands for no-load AGV waiting zone; 38 stands for gantry crane; 39 stands for hole; 40 stands for lining; 41 stands for underground work area; 42 stands for front buffer zone; 43 stands for back buffer zone; 44 stands for maintenance track; 45 stands for first turnback zone; 46/47 stands for second turnback zone/emergency zone; 48 stands for slope buffer zone; 49 stands for slope; 50 stands for shuttle vehicle; 51 stands for charging pile; 52 stands for track; 53 stands for drainage ditch; 54 stands for blind ditch; 55 stands for fire-fighting equipment; 56 stands for ventilation device; 57 stands for lighting device; 58 stands for emergency communication device; 58 stands for second shaft mouth.

### EMBODIMENTS

Embodiments of the present invention are described in detail below, and examples of said embodiments are shown in the attached drawings where identical or similar labels throughout indicate identical or similar elements or elements having the same or similar function. The embodiments described below by reference to the attached drawings are illustrative and are only employed to explain the present invention, not to be understood as limitations of the present invention.

In the description of the present invention, it is necessary to understand that the term “center”, “vertical”, “horizontal”, “length”, “width”, “thickness” and “up”, “down”, “before” and “after”, “left”, “right” and “vertical”, “level”, “top”, “bottom”, “inside” and “outside”, “clockwise” and “rotate”, “axis”, “radial” and “to the” instructions for the location or position relations. The orientation or position relations shown in the attached drawings are intended only to facilitate the description of the present invention and simplify the description, and are not intended to indicate or imply that the device or component referred to must have a specific orientation, be constructed, and operated in a specific orientation, and therefore shall not be construed as a limitation of the present invention.

In addition, the terms “first” and “second” are employed for descriptive purposes only and are not to be understood to indicate or imply relative importance or to indicate implicitly the quantity of indicated technical features. Thus, features that are qualified as “first” or “second” may include, explicitly or implicitly, one or more of these features. In the description of the present invention, “multiple” means two or more, unless otherwise expressly and specifically qualified.

In the present invention, unless otherwise expressly specified and qualified, the terms “mounting”, “connecting”, “fastening”, etc., shall be interpreted broadly, for example, as fixed connection, detachable connection, or integrated. It can be mechanical or electrical. It can be directly connected, or indirectly connected via an intermediate medium. It can be the internal connection of two components or the interaction of two components. For ordinary technicians in the field, the specific meanings of the above terms in the present invention can be understood according to the specific circumstances.

In the present invention, unless otherwise expressly specified and qualified, the first feature “above” or “below” the second feature may be in direct contact with the first and second features, or in indirect contact with the first and second features via an intermediate medium. Moreover, the first feature is “above”, “above” and “above” the second feature, but the first feature is directly above or diagonally above the second feature, or merely indicates that the horizontal height of the first feature is higher than the second feature. The first feature “below”, “below” and “below” the second feature can be either directly or diagonally below the second feature, or simply indicate that the horizontal height of the first feature is less than the second feature.

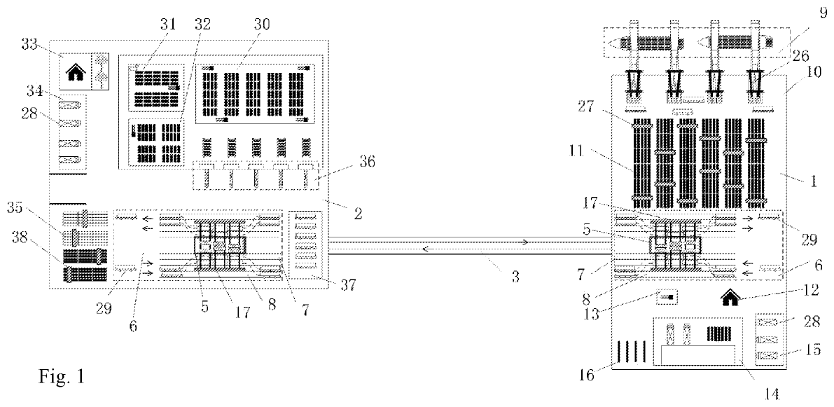

Please refer to FIG. 1, the underground container logistics loading and unloading system based on the deep underground passage, including: the automatic container terminal 1, the logistics park 2, and the deep underground passage 3.

The automatic container terminal 1 and the logistics park 2 are connected via the deep underground passage 3. Both the automatic container terminal 1 and the logistics park 2 are a rectangular area. The deep underground passage is a slender area.

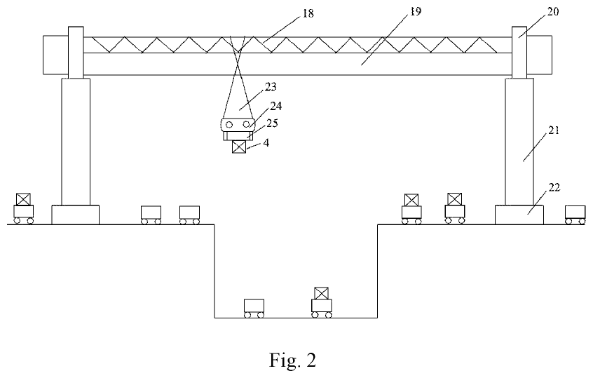

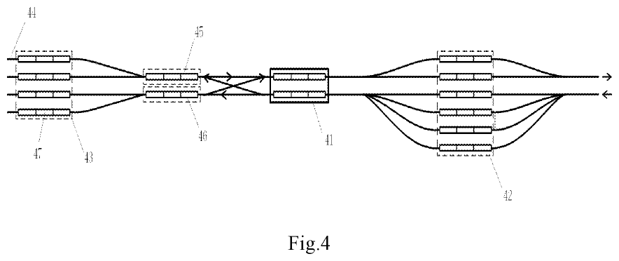

Please refer to FIG. 2 and FIG. 4, the deep underground passage 3 comprises: a main layout and an accessory equipment. The main layout comprises: the underground work area 41, the front buffer zone 42, the back buffer zone 43, the multitude of maintenance tracks 44, the first turnback zone 45, the second turnback zone 46, an emergency zone 47, the slope buffer zone 48, and slopes 49. All parts of the main layout area are connected two by two by tracks. The underground work area 41 is directly below the first shaft mouth 5, 10 meters deep underground. The front buffer zone 42 is 75 meters distant from the underground work area 41 for parking of the multitude of shuttle vehicles 50. 4 tracks in the front buffer zone 42 are employed for the multitude of shuttle vehicles 50 waiting to unload containers and 2 tracks are employed for the multitude of shuttle vehicles 50 waiting to enter the deep underground passage 3. The first turnback zone 45 is located behind the underground work area 41 for the multitude of shuttle vehicles 50 turnback. The second turnback zone 46/emergency zone 47 is located behind the underground work area 41 for the multitude of shuttle vehicles 50 turnback or emergency. The back buffer zone 43 is located at the back of the turnback zone for the multitude of shuttle vehicles 50 for the parking of. In case of failure or congestion in the turnback zone, the multitude of shuttle vehicles 50 can transport to the back buffer zone 43 via the emergency zone 47 until the problem is solved. The underground work area 41, the front buffer zone 42, the first turnback zone 45, the second turnback zone 46 and emergency zone 47 are all rectangular areas. The multitude of maintenance tracks 44 are located in the back buffer zone 43, which is employed for daily maintenance of the multitude of shuttle vehicles 50.

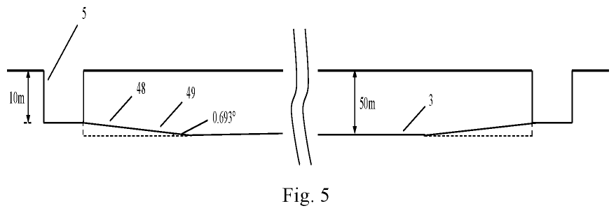

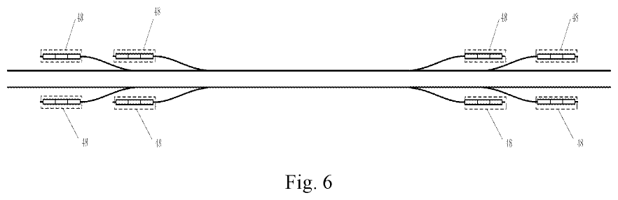

Referring to FIG. 5 and FIG. 6, the slopes 49, located on both sides of the deep underground passage 3, is employed to connect the 10 m deep section of the deep underground passage 3 to the 50 m deep section. The slope buffer zones 48 are installed at the slopes 49 for the temporary parking of the multitude of shuttle vehicles 50. The slopes 49 and the slope buffer zones 48 are all rectangular areas.

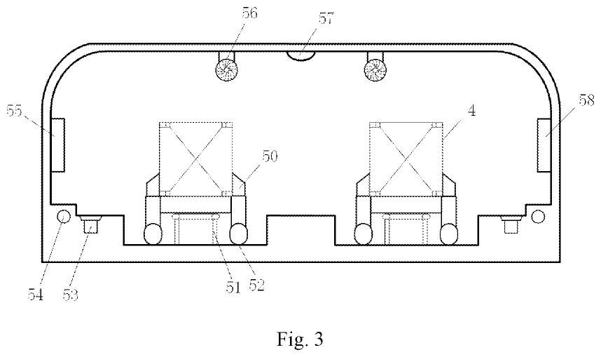

Referring to FIG. 3, the accessory equipment comprises: the multitude of charging piles 51, the multitude of tracks 52, the drainage ditches 53, the blind ditches 54, the fire-fighting equipment 55, the ventilation device 56, the lighting device 57, and the emergency communication device 58. The multitude of tracks 52 are laid on the surface of the deep underground passage 3, employed for the multitude of shuttle vehicles 50 operation. The multitude of charging piles 51 are located on the multitude of tracks 52, and the multitude of charging piles 51 are set every 20 meters for power supply of the multitude of shuttle vehicles 50. One side of the deep underground passage 3 wall is provided with the fire-fighting equipment 55, the other side is provided with the emergency communication device 58. The ventilation device 56 is located at the top of the deep underground passage 3 for discharging harmful gases. The lighting device 57 is located on the top of the deep underground passage 3 and close to the wall for lighting in the passage. The drainage ditches 53 are located at both ends of the ground of the deep underground passage 3 for water diversion. The blind ditches 54 are located at both ends of the deep underground passage 3 to remove groundwater and reduce groundwater level.

Understandably, the automatic container terminal 1 and the logistics park 2 are connected via the deep underground passage 3, and the multitude of shuttle vehicles 50 are employed to transport containers 4 between the automatic container terminal 1 and the logistics park 2. The underground work area 41 is 10 meters deep, and the main line of the deep underground passage 3 is 50 meters deep. The deep underground passage 3 is equipped with the main layout and the accessory equipment. The multitude of shuttle vehicles 50 can only be transported in the deep underground passage 3, and the deep underground passage 3 can only be operated by the multitude of shuttle vehicles 50.

It should be noted that the main layout comprises: a hole 39, a lining 40, the underground work area 41, the front buffer zone 42, the back buffer zone 43, the multitude of maintenance tracks 44, the first turnback zone 45, The second turnback zone 46/emergency zone 47, the slopes buffer zone 48, and slopes 49. The underground work area 41 is located directly below the first shaft mouth 5 of the automatic container terminal 1 and the logistics park 2 respectively, which is employed to load and unload the multitude of shuttle vehicles 50. The underground work area 41, the front buffer zone 42, the back buffer zone 43, the multitude of maintenance tracks 44, the first turnback zone 45, The second turnback zone 46/emergency zone 47 are located at a depth of 10 meters. Referring to FIG. 5, the slopes 49 are employed to connect the 10 m deep working section of the deep underground passage 3 and the 50 m deep main transport section. The slope angle is 0.693°.

The hole 39 is employed to bear the pressure of surrounding rock, bear the weight of the structure, waterproof in the cave, and prevent the surrounding rock from weathering. The lining 40 is a permanent structure that supports and maintains the long-term stability and durability of the deep underground passage 3. The underground work area 41 is located directly below the first shaft mouth 5 of the automatic container terminal 1 and the logistics park 2, namely at both ends of the deep underground passage 3, which is employed to realize the underground loading and unloading of the multitude of shuttle vehicles 50 in the automatic container terminal 1 and the logistics park 2. The accessory equipment is provided with the multitude of charging piles 51, the multitude of tracks 52, the drainage ditches 53, the blind ditches 54, the fire-fighting equipment 55, the ventilation device 56, the lighting device 57, the emergency communication device 58. The multitude of tracks 52 are laid on the surface of the deep underground passage 3, employed for the multitude of shuttle vehicles 50 operation. The multitude of charging piles 51 are located on the multitude of tracks 52, and the multitude of charging piles 51 are set every 20 meters for power supply of the multitude of shuttle vehicles 50. The drainage ditches 53, located at both ends of the ground of the deep underground passage 3, is mainly employed for water diversion and directs the water flow of various water sources within the scope of the deep underground passage 3 to designated locations outside the scope of the deep underground passage 3. The blind ditches 54, located at both ends of the deep underground passage 3, is a kind of underground drainage passage, which is employed to remove groundwater and reduce the groundwater level. The ventilation device 56 is located at the top of the deep underground passage 3, which is employed to discharge harmful gases from construction or operation. The fire-fighting equipment 55 is located on one side of the wall of the deep underground passage 3. It is the automatic fire alarm system, fire hydrant, and other fixed facilities in the deep underground passage 3, which is employed to prevent and respond to fire injury accidents. The emergency communication device 58 is located on the other side of the wall of the deep underground passage 3. It provides special communication for emergency rescue in case of traffic accidents. It mainly refers to emergency alarm telephone terminal, which integrates communication, broadcasting, command and dispatch, power amplifier (30 W), switching quantity, handle, and other interfaces and functions. The lighting device 57 is located at the top of the deep underground passage 3 for lighting in the passage.

Preferably, the automatic container terminal 1 comprises: the first shaft mouth 5, the ground work area 6, the multitude of AGV operation lanes 7, the multitude of AGV running lanes 8, the berth 9, the terminal front 10, the terminal yard 11, a terminal office building 12, a maintenance room 13, the container freight station 14, the terminal lot 15, a terminal gate 16, the multitude of three-beam fixed cranes 17, the multitude of coast cranes 26, the multitude of automatic stacking cranes 27, the container trucks, and the multitude of the AGVs 29. The first shaft mouth 5 is connected to the ground of the automatic container terminal 1 and the deep underground passage 3 nodes by vertical loading and unloading. The ground work area 6 is employed to load and unload of the multitude of the AGVs 29 near the first shaft mouth 5. The ground work area 6 is a rectangular area. The multitude of AGV operation lanes 7, located on either side of the first shaft mouth 5, is employed to load and unload operations the multitude of the AGVs 29. The multitude of AGV running lanes 8, located on both sides of the first shaft mouth 5, is employed for the multitude of the AGVs 29 operation. The berth 9 is employed to dock the container vessels. The berth 9 is a rectangular area. The terminal yard 11, employed to load and unload containers 4 handover, storage. The terminal yard 11 is a rectangular area. The terminal office building 12 is employed for the exercise of the automatic container terminal 1 facilities of the functional center organization. The maintenance room 13 is the place employed for overhaul and maintenance. The container freight station 14 is employed to load and unpack the multitude of containers 4. The terminal parking lot 15 is employed for the temporary parking of the container trucks 28 in the automatic container terminal 1. The terminal gate 16 is employed to distinguish internal and external responsibilities and handover related information of the automatic container terminal 1. The terminal office building 12, the maintenance room 13, the container freight station 14, the terminal parking lot 15 and the terminal gate 16 are all rectangular areas. The multitude of three-beam fixed cranes 17, located directly above the first shaft mouth 5, is employed to load and unload AGVs 29 and the multitude of shuttle vehicles 50. The multitude of coast cranes 26 are employed to load and unload the container vessels. The multitude of automatic stacking cranes 27 are employed to load, unload and stack containers 4. The container trucks 28 are employed to transport detachable the multitude of containers 4. The multitude of the AGVs 29 are employed to transport the multitude of containers 4 between the terminal yard 11 and the multitude of coast cranes 26, and to interact the multitude of containers 4 with the multitude of shuttle vehicles 50 by the multitude of three-beam fixed cranes 17 directly above the first shaft mouth 5.

It should be noted that the automatic container terminal 1 comprises: the first shaft mouth 5, the ground work area 6, the multitude of AGV operation lanes 7, the multitude of AGV running lanes 8, the berth 9, the terminal front 10, the terminal yard 11, the terminal office building 12, the maintenance room 13, the container freight station 14, the terminal parking lot 15, the terminal gate 16. The first shaft mouth 5 is connected to the ground of the automatic container terminal 1 and the deep underground passage 3 nodes by vertical loading and unloading. The ground work area 6 is located on the ground on both sides of the first shaft mouth 5, specifically at the junction of the multitude of AGV operation lanes 7 and the multitude of three-beam fixed cranes 17. It is the zone where the multitude of the AGVs 29 carry out the multitude of containers 4 unloading and packing operations. The AGV operation lanes 7 and the multitude of AGV running lanes 8 are both set on both sides of the first shaft mouth 5. The multitude of the AGVs on both sides run in opposite directions, and 4 lanes are located on each side. The inside 2 lanes of each running direction are the multitude of AGV operation lanes 7, and the outside 2 lanes are the multitude of AGV running lanes 8. The multitude of AGV operation lanes 7 are employed to load and unload the multitude of the AGVs 29. The multitude of AGV running lanes 8 are only for the multitude of the AGVs 29 driving. The berth 9 is for the container vessels to the berth and operation. The terminal front 10 mainly comprises the distance from quayside line to the first rail of the multitude of coast cranes 26 (seaward side), the distance between the rails of the multitude of coast cranes 26, and the distance from the second rail of the multitude of coast cranes 26 (landside) to the front of the yard. The terminal yard 11 is employed to handle the handover, storage, and storage of the multitude of containers 4 from the automatic container terminal 1. The terminal office building 12 is the central organization to operate and manage the facilities of the automatic container terminal 1. The maintenance room 13 is a place for repairing and maintaining special machinery and the multitude of containers 4 in the automatic container terminal 1. The container freight station 14 is employed to load and unpack the multitude of containers 4. The terminal parking lot 15 is employed for the temporary park of the container trucks 28 in the automatic container terminal 1. The terminal gate 16 is the place to distinguish the internal and external responsibilities of the automatic container terminal 1 and to transport relevant data. The automatic container terminal 1 is equipped with the multitude of three-beam fixed cranes 17, the multitude of coast cranes 26, the multitude of automatic stacking cranes 27, the container trucks 28, and the multitude of the AGVs 29. The multitude of three-beam fixed cranes 17 are located directly above the first shaft mouth 5, which is employed to load and unload the multitude of shuttle vehicles 50 and AGVs 29 to realize the interaction between underground and ground containers 4. The three-beam fixed operate 17 comprises: a slideway 18, a beam 19, a fixed crane lighting device 20, a column 21, a fixed groove 22, a chain 23, a motor 24, a transmission wheel set 25, a connection with the ground via the fixed groove 22, the main body is composed of three groups of the beams, each group of the beams 19 has 2 cars, 2 cars are set side by side, each trolley is connected with a spanner via the chain 23, which can realize the multitude of three-beam fixed cranes 17 to grab 6 containers 4 at the same time. The multitude of coast cranes 26 are professional equipment employed to load and unload the container vessels in container terminals. The automatic stacking crane 27 employed to load, unload and stack the multitude of containers 4 in railway container transport yard and large containers 4 storage and transportation yard. The container trucks 28 refer to special transport vehicle for transporting detachable the multitude of containers 4. The multitude of the AGVs 29 refer to a vehicle equipped with electromagnetic or optical guidance devices, which can transport according to the specified guiding route, and has a vehicle running and stopping device, safety protection device, and transport the multitude of containers 4 with various load shifting functions.

In one way, the logistics park 2 comprises: the second shaft mouth 59, the ground work area 6, the multitude of AGV operation lanes 7, the multitude of AGV running lanes 8, the warehouse 30, the sorting zone 31, the distribution zone 32, a dispatching center 33, a parking 34, the park yard 35, the park ground cargo loading and unloading zone 36, the no-load AGV waiting zone 37, the multitude of three-beam fixed cranes 17, the multitude of the AGVs 29, the gantry cranes 38, the container trucks 28. The second shaft mouth 59 is located at the side of the park yard 35 of the park, connecting the ground of the logistics park 2 and the deep underground passage 3 nodes by vertical loading and unloading mode. The ground work area 6 is employed to load and unload the multitude of the AGVs 29 near the second shaft mouth 59. The ground work area 6 is a rectangular area. The multitude of AGV operation lanes 7, located on either side of the second shaft mouth 59, is employed to load and unload the multitude of the AGVs 29. The multitude of AGV running lanes 8, located on both sides of the second shaft mouth 59, is employed to operate the multitude of the AGVs 29. The no-load AGV waiting zone 37, located at the end of the AGV driveway near the second shaft mouth 59, refers to the no-load waiting zone after the unloading operation of the multitude of the AGVs 29 are completed. The park yard 35, located near the second shaft mouth 59, is employed to hand over and store the multitude of containers 4 in the logistics park 2. The park ground cargo loading and unloading zone 36, located in the middle of the logistics park 2, has 5 loading and unloading ports for loading and unloading the multitude of containers 4 delivered by surface the container trucks 28. The warehouse 30 is located behind the park ground cargo loading and unloading zone 36 of the park for bulk storage of goods. The sorting zone 31, located at the side of the warehouse 30, is employed for automatic sorting of parcels according to certain rules. The distribution zone 32, located at the side of the warehouse 30, is employed to complete orders according to the requirements of the distribution to the designated location. The parking 34, located on the inside side of the gate of the logistics park 2, is employed for the parking of the container trucks 28 entering and leaving the logistics park 2. The dispatching center 33 is located on the side of the parking 34 and behind the logistics park 2, which is employed to establish a reasonable dispatching management organization system for the logistics park 2. The no-load AGV waiting zone 37, the park yard 35, the park ground cargo loading and unloading zone 36, the warehouse 30, the sorting zone 31, the distribution zone 32, the dispatching center 33 and the parking 34 are all rectangular areas.

Understandably, the logistics park 2 comprises: the second shaft mouth 59, the ground work area 6, the multitude of AGV operation lanes 7, the multitude of AGV running lanes 8, the warehouse 30, the sorting zone 31, the distribution zone 32, the dispatching center 33, the parking 34, the park yard 35, the park ground cargo loading and unloading zone 36, the no-load AGV waiting zone 37, the multitude of three-beam fixed cranes 17, the multitude of the AGVs 29, the gantry cranes 38, the container trucks 28. The second shaft mouth 59 is located at the side of the storage yard 35 of the park, connecting the ground of the logistics park 2 and the deep underground passage 3 nodes by vertical loading and unloading mode. The ground work area 6 is located on the ground on both sides of the second shaft mouth 59, specifically at the junction of the multitude of AGV operation lanes 7 and the multitude of three-beam fixed cranes 17. It is the zone where the multitude of the AGVs 29 carry out the multitude of containers 4 unloading and packing operations. The multitude of AGV operation lanes 7 and the multitude of AGV running lanes 8 are both set on both sides of the second shaft mouth 59. The multitude of the AGVs on both sides run in opposite directions, and 4 lanes are located on each side. The inside 2 lanes of each running direction are the multitude of AGV operation lane 7, and the outside 2 lanes are the multitude of AGV running lanes 8. The multitude of AGV operation lanes 7 are employed to load and unload the multitude of the AGVs 29. The multitude of AGV running lanes 8 are only for the multitude of the AGVs 29 driving. The no-load AGV waiting zone 37, located at the end of the AGV driveway near the second shaft mouth 59, refers to the no-load waiting zone after the unloading operation of the multitude of the AGVs 29 are completed. The park yard 35, located near the second shaft mouth 59, is employed to hand over and store the multitude of containers 4 in the logistics park 2. The park ground cargo loading and unloading zone 36, located in the middle of the logistics park 2, has 5 loading and unloading ports for loading and unloading the multitude of containers 4 delivered by surface the container trucks 28. The warehouse 30 is located behind the park ground cargo loading and unloading zone 36 of the park for bulk storage of goods. The sorting zone 31, located at the side of the warehouse 30, is employed for automatic sorting of parcels according to certain rules. The distribution zone 32, located at the side of the warehouse 30, is employed to complete orders according to the requirements of the distribution to the designated location. The parking 34, located on the inside side of the gate of the logistics park 2, is employed for the parking of the container trucks 28 entering and leaving the logistics park 2. The dispatching center 33, located at the side of the parking 34 and behind the logistics park 2, is employed to establish a reasonable dispatching management organization system for the logistics park 2. The park yard 57 is employed to hand over and store the multitude of containers 4 in the park 2. The warehouse 51 is employed for bulk storage of goods. The ground cargo loading and unloading zone 58 is located in the middle of the park 2, with a total of 5 loading and unloading ports. The sorting zone 52 carries out automatic sorting of packages according to certain rules. The distribution zone 53 distributed completed orders to the specified location according to the requirements. The parking 34 is employed for the parking of the container trucks 28 entering and leaving the park 2. The dispatching center 54 establishes a reasonable dispatching management organization system of the park 2. The second shaft mouth 59 is located at the back of the park yard 57, connecting the park 2 ground and underground deep passage 3 nodes by vertical loading and unloading mode. The ground cargo loading and unloading zone 1 is located at the back of the park yard 57 and is the ground and underground loading and unloading zone near the second shaft mouth 59. The logistics park 2 comprises: the multitude of three-beam fixed cranes 17, the multitude of the AGVs 29, the gantry cranes 38, the container trucks 28. The multitude of three-beam fixed cranes 17 are located directly above the second shaft mouth 59, which is employed to load and unload the multitude of shuttle vehicles 50 and AGVs 29 to realize the interaction between underground and ground containers 4. The multitude of three-beam fixed cranes 17 comprises: the slideway 18, the beam 19, the fixed crane lighting device 20, the column 21, the fixed groove 22, the chain 23, the motor 24, the transmission wheel set 25, connected with the ground via the fixed groove 22. The main body is composed of three groups of the beams. Each group of the beams 19 has 2 cars, and 2 cars are set side by side. Each trolley is connected with a spanner via the chain 23, which can realize the multitude of three-beam fixed cranes 17 to grab 6 containers 4 at the same time. The gantry cranes 38 are responsible for loading, unloading, loading and unloading and stacking the multitude of containers 4 in the park yard 35. The multitude of the AGVs 29 refer to is equipped with electromagnetic or optical guiding device, can according to the regulation of direct route, with the car running and stop device, safety device, and which has the function of various transplanting transportation of the container trucks 28, for the interaction of the multitude of containers 4 with the multitude of shuttle vehicles 50 via the multitude of three-beam fixed cranes 17 directly above the second shaft mouth 59. The container trucks 28 refer to special transport vehicle for transporting detachable the multitude of containers 4.

It should be noted that the multitude of the AGVs can transport via the automatic container terminal 1 and, in addition to transporting out its existing operations in the automatic container terminal. Transportation can be carried out in the ground work area 6, the multitude of AGV operation lanes 7, and the multitude of AGV running lanes 8 near the second shaft mouth 59. The multitude of the AGVs 29 can operate in the ground work area 6 of the logistics park 2, and the AGV 29 can also wait in the no-load AGV waiting zone 37. The AGV running lane is employed to transport the multitude of the AGVs 29.

The existing operations in the logistics park of the automatic container terminal are: the multitude of the AGVs can only operate (transport) at the terminal front 10 and the container trucks 28 can only operate (transport) in the zone behind the terminal yard 11, i.e., near the terminal gate 16. The existing operations in the logistics park are: all ground transport is carried out by the container trucks 28.

In embodiments of the present invention, the deep underground passage 3 and its interior can only be transported (operated) by the multitude of shuttle vehicles transportation (operation), the logistics park is introduced into the multitude of the AGVs transportation (operation), the automatic container terminal 1 increased with the multitude of three-beam fixed cranes, the ground work area, the multitude of AGV operation lanes, the multitude of AGV running lanes, the logistics park to join the multitude of three-beam fixed cranes, the ground work area, the multitude of AGV operation lanes, the multitude of AGV running lanes, the no-load AGV waiting zone and so on are related to the multitude of the AGVs, thus contributing to the way of the multitude of the AGVs operation.

The multitude of the AGVs can operate (transport) in the multitude of the AGVs scope designated by the automatic container terminal 1 and the logistics park 2, but not in the deep underground passage 3. The container trucks can only be transported on the ground, and can operate (transport) in the rear of the automatic container terminal 1 and the logistics park 2, but cannot be transported in the deep underground passage 3. The multitude of shuttle vehicles can only operate in the deep underground passage 3.

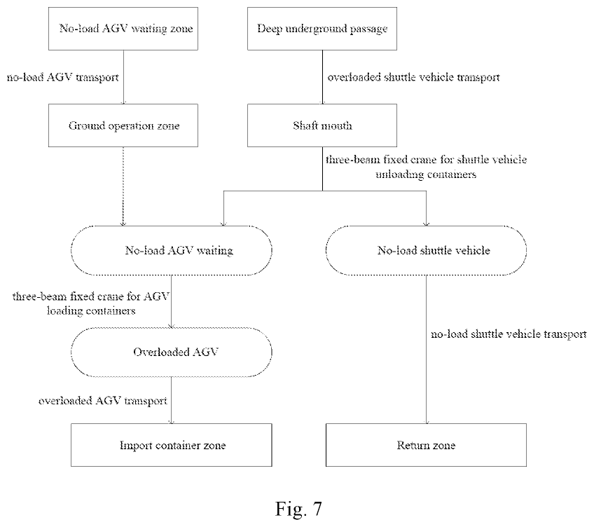

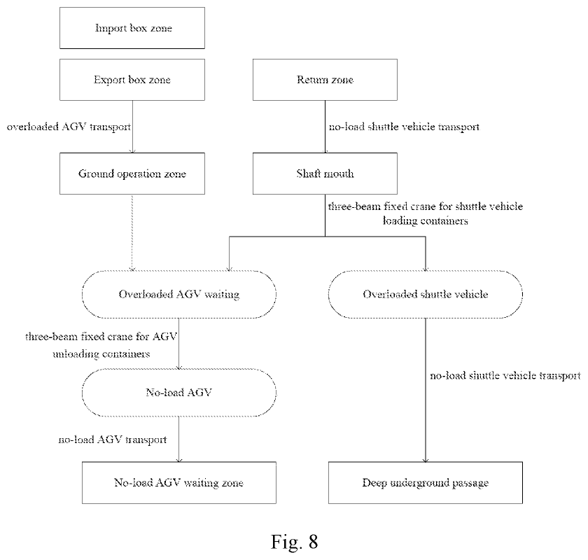

Specifically, after the introduction of the deep underground passage 3, the detailed analysis is carried out by combining FIG. 7 and FIG. 8 of the automatic container terminal 1 and the logistics park 2. There are the subsequent two routes when working:

From the automatic container terminal to the logistics park:

The AGV cycle: The overloaded AGVs 29 of the automatic container terminals 1 starts from the exit container zone and runs along the multitude of AGV running lanes 8 to the ground work area 6. After the no-load shuttle vehicles 50 arrives at the underground work area 41 of the first end of the automatic container terminal, three-beams fixed crane 17 to unload the multitude of the AGVs 29, and the multitude of containers 4 are placed on the multitude of shuttle vehicles 50. Then the no-load AGVs 29 sailing zone waiting for a new load task, when the overloaded shuttle vehicles 50 reach the underground work area 41 at the end of the automatic container terminal 1, the no-load AGVs 29 received instruction in advance from the waiting zone along the multitude of AGV running lanes 8 driving to the ground work area 6, the last overloaded the multitude of the AGVs 29 transport the container 4 to import container zone.

Shuttle vehicle cycle: The overloaded shuttle vehicles 50 transport from the logistics park 2 along the deep underground passage 3 to the front buffer zone 42 at the end of the automatic container terminal 1. If the underground work area 41 is idle, it transports to the underground work area 41 for unloading. If the underground work area 41 is busy, it waits in the front buffer zone 42 until the underground work area 41 is idle. After the overloaded shuttle vehicles 50 are unloaded in the underground work area 41 by the multitude of three-beam fixed cranes 17, the no-load vehicles 50 arrive at the underground work area 41 of another track again via the first turnback zone 45, waits for the multitude of three-beam fixed cranes 17 to load it, and the overloaded shuttle vehicles 50 leave the underground work area 41 at the end of the automatic container terminal 1 and goes to the logistics park 2 along the deep underground passage 3.

From the logistics park to the automatic container terminal:

The AGV cycle: The overloaded AGV 29 in the logistics park 2 starts from the exit container zone and runs along the multitude of AGV running lanes 8 to the ground work area 6. After the no-load shuttle vehicles 50 arrive at the underground work area 41 at the end of the logistics park 2, the three-beams fixed cranes 17 to the no-load AGVs 29, and the multitude of containers 4 are placed on the multitude of shuttle vehicles 50. Then the no-load AGVs 29 transport to the no-load AGV waiting zone 37 to wait for the new loading task. When the heavy-load shuttle vehicles 50 arrive at the underground work area 41 at the end of the second end of the logistics park, the no-load AGVs 29 receive instructions in advance to transport from the no-load AGV waiting zone 37 along the multitude of AGV running lanes 8 to the ground work area 6 for packing operation. Finally, the overloaded AGVs 29 will transport the multitude of containers 4 to the inlet container zone.

Shuttle vehicle cycle: The overloaded shuttle vehicles 50 transports from the automatic container terminal 1 along the deep underground passage 3 to the front buffer zone 42 at the end of the logistics park 2. If the underground work area 41 is idle, it transports to the underground work area 41 for unloading. If the underground work area 41 is busy, it waits in the front buffer zone 42 until the underground work area 41 is idle. After the overloaded shuttle vehicles 50 are unloaded in the underground work area 41 by the multitude of three-beam fixed cranes 17, the no-load shuttle vehicles 50 arrive at the underground work area 41 of another track again via the first turnback zone 45, and waits for the multitude of three-beam fixed cranes 17 to load it. The overloaded shuttle vehicles 50 leave the underground work area 41 at the end of the logistics park 2 and goes to the automatic container terminal 1 along the deep underground passage 3.

The container transportation procedure at the automatic container terminal 1 with the underground logistics system consists of two parts: above-ground and underground. For the above-ground part, in a departure terminal a set of the multitude of containers 4, denoted as D, are transported by a set of AGVs 29 to the first shaft mouth 5. There are a set of the multitude of three-beam fixed cranes 17 above the first shaft mouth 5, denoted as K, and the multitude of three-beam fixed cranes 17 operate and transport the multitude of containers 4 from the multitude of the AGVs 29 to the multitude of shuttle vehicles 50 in the deep underground passage 3. For the underground part, the multitude of shuttle vehicles 50 have a given marshaling policy and leaving frequency. The multitude of shuttle vehicles 50 transport the multitude of containers 4 to the destination terminal, where there is also the first shaft mouth 5 equipped with a set of the multitude of three-beam fixed cranes 17 denoted as G. The multitude of three-beam fixed cranes 17 operate and transport the multitude of containers 4 from the multitude of shuttle vehicles 50 to the multitude of the AGVs 29 at the destination terminal. Whenever there are shuttle vehicles 50 at the first shaft mouth 5 and the multitude of three-beam fixed cranes 17 are busy, new coming shuttle vehicles 50 have to be waiting in a buffer zone until the first shaft mouth 5 and the multitude of three-beam fixed cranes 17 are idle.

Without of loss of generality, we have the subsequent assumptions:
(1) The multitude of the AGVs 29 transporting the multitude of containers arrives at the multitude of three-beam fixed cranes 17 of the departure terminal at a given frequency, and the multitude of the AGVs 29 are enough at the destination terminal such that the corresponding the multitude of three-beam fixed cranes 17 do not need to wait after transporting the multitude of containers 4 to above-ground.
(2) All the multitude of containers 4 are 40 feet in size, each three-beam fixed cranes only grabs one container 4 at a time, and the time of a single operation is considered to be a given constant.
(3) The one-trip transportation time of the multitude of shuttle vehicles 50 in the deep underground passage 3 is a given constant;
(4) The multitude of the AGVs 29 has no waiting time during horizontal transportation and in the storage zone, and handles one container 4 per time.

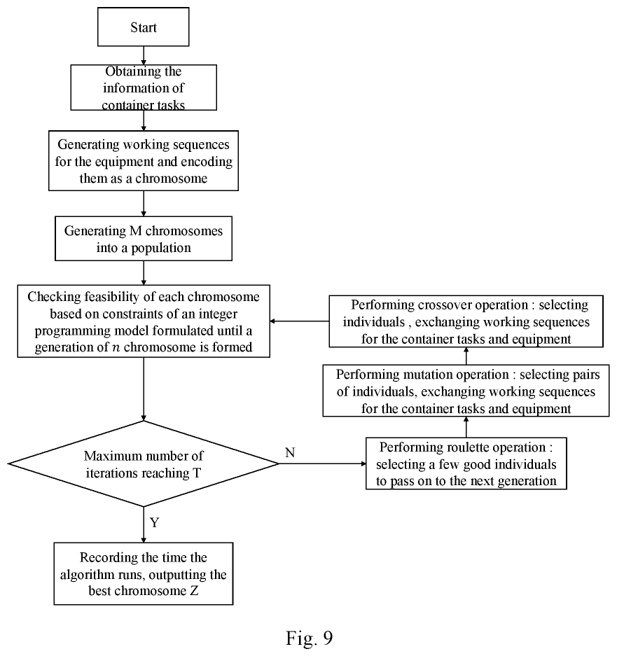

Refer to FIG. 9, with the sets and notations, a method for solving the joint scheduling of the multitude of three-beam fixed cranes 17 and the multitude of shuttle vehicles 50 is based on an integer programming model formulated and a Genetic Algorithm, wherein the method comprises the subsequent steps:
step 1, inputting a number T to control the number of times the algorithm is performed, usually taking values from 100 to 500; letting t=1; indexing the multitude of containers from 1 to n, defining a sequence of 2n integers as a chromosome, in which the first n integers representing an index of the multitude of three-beam fixed cranes at a departure terminal assigned to handle each of the multitude of containers, and subsequent n integers representing each index of the multitude of three-beam fixed cranes at a destination terminal assigned to handle each of the multitude of containers;
step 2, for a population size M, randomly generating M chromosomes as a population P(t), wherein an m-th chromosome is noted as P(m, t); checking feasibility of each chromosome based on subsequent constraints of an integer programming model formulated: given D being the index of the multitude of containers to be handled, K being the index of the multitude of three-beam fixed cranes at the departure terminal, G being the index of the multitude of three-beam fixed cranes at the destination terminal, V being the index of the multitude of shuttle vehicles, and xᵢₖᵥ being a 0-1 variable with xᵢₖᵥ=1 if the container i being handled by the three-beam fixed crane k at the first shaft mouth of the departure terminal and is loaded by the shuttle vehicle v, otherwise xₖᵢᵥ=0, sᵢₖᵥ being the starting time of the three-beam fixed crane k unloading the container i from the AGV to the shuttle vehicle v at the first shaft mouth of the departure terminal, tᵢ being the arrival time of the AGV carried the container i, hᵥ being the real leaving time of the shuttle vehicle v at the destination terminal, lᵥ being the planning time of the shuttle vehicle v arriving at the first shaft mouth of the departure terminal, as lᵥ=u(v−1), zᵢⱼₖ being a 0-1 variable with zᵢⱼₖ=1 if the container i and j being both handled by the three-beam fixed crane k at the departure terminal, and the container j being handled just after the container i is finished, otherwise zᵢⱼₖ=0, T being processing time of handling one container by the three-beam fixed crane at the first shaft mouth, O_{igv} being the starting time of the three-beam fixed crane g unloading the container i from the shuttle vehicle v at the destination terminal;
   with the constraint (1) as

Σ_{i∈D}Σ_{k∈K}Σ_{v∈V}xᵢₖᵥ=1,Σ_{i∈D}Σ_{g∈G}Σ_{v∈V}y_{igv}=1 (1)

wherein y_{igv} being a 0-1 variable with y_{igv}=1 if the container i being transported by the shuttle vehicle v and being handled by the three-beam fixed crane k at the first shaft mouth of the destination terminal, otherwise y_{igv}=0;
with the constraint (2) as

Σ_{i∈D}Σ_{k∈K}xᵢₖᵥ=c,Σ_{i∈D}Σ_{g∈G}y_{igv}=c,v=1,2, . . . |V| (2)

wherein c being an index of the multitude of shuttle vehicles;
with the constraints (3) to (6) as

Σ_{i∈D}Σ_{k∈K}zᵢⱼₖ≤1,∀j∈D (3)

Σ_{j∈D}Σ_{k∈K}zᵢⱼₖ≤1,∀i∈D (4)

Σ_{i∈D}Σ_{g∈G}w_{ijg}≤1,∀j∈D (5)

Σ_{j∈D}Σ_{g∈G}w_{ijg}≤1,∀i∈D (6)

wherein w_{ijg} being a 0-1 variable with wᵢⱼₖ=1 if the container i and j being both handled by the three-beam fixed crane k at the destination terminal, and the container j being handled just after the container i is finished, otherwise wᵢⱼₖ=0;
with the constraint (7) as

sᵢₖᵥ−tᵢ≥M(xᵢₖᵥ−1),∀i∈D∀k∈K₁∀v∈V (7)

wherein M being a sufficient large constant;
with the constraint (8) as

sᵢₖᵥ−lᵥ≥M(xₖᵢᵥ−1),∀i∈D∀k∈K₁∀v∈V (8)

with the constraint (9) as

sⱼₖᵥ−sᵢₖᵥ−T≥M(zᵢⱼₖ−1),∀i,j∈D∀k∈K₁ (9)

with the constraint (10) as

eᵥ−(sᵢₖᵥ+T)≥M(xᵢₖᵥ−1),∀i∈D∀k∈K₁∀v∈V (10)

wherein eᵥ being the real arrival time of the shuttle vehicle v at the first shaft mouth of the departure terminal;
with the constraint (11) as

p_{igv}=(eᵥ+L)*y_{igv},∀i∈D∀g∈G∀v∈V (11)

wherein p_{igv} being the real arrival time of the shuttle vehicle v at the three-beam fixed crane g of the destination terminal, L being single-trip traveling time of the multitude of shuttle vehicles in the deep underground passage;
with the constraint (12) as

O_{igv}−(p_{igv}+T)≥M(y_{igv}−1),∀i∈D∀g∈G∀v∈V (12)

with the constraint (13) as

O_{jgv}−O_{igv}−T≥M(w_{ijg}−1),∀i,j∈D∀g∈G (13)

with the constraint (14) as

hᵥ−(o_{igv}+T)≥M(y_{igv}−1),∀i∈D∀g∈G∀v∈V (14)
step 3, letting m=1, decoding the m-th chromosome in the population from 1 to 2n as an operation sequence of the multitude of containers for the equipment, ensuring both the optimal solution and the fast convergence of the algorithm, calculating a fitness value of the chromosome as an inverse of subsequent objective function for minimizing a total weighted waiting time of the multitude of three-beam fixed cranes at the first shaft mouth, the multitude of shuttle vehicles in the deep underground passage:

MinW=αΣ_{i∈D}Σ_{k∈K}Σ_{v∈V}xₖᵢᵥ(sᵢₖᵥ−tᵢ)+βΣ_{v∈V}(hᵥ−lᵥ)+γΣ_{i∈D}Σ_{k∈K}Σ_{j∈D}zᵢⱼₖ(Σ_{v∈V}sⱼₖᵥ−Σ_{v∈V}sᵢₖᵥ−T)+γΣ_{i∈D}Σ_{g∈G}Σ_{j∈D}w_{ijg}(Σ_{v∈V}o_{jgv}−Σ_{v∈V}o_{igv}−T),

wherein α, β and γ being the corresponding weight parameters, obtaining the fitness value of each chromosome as

fitness=1/W;
identifying the best chromosome in current generation with the maximum fitness value; incrementing m by one, on condition m=M, proceeding to step 4, otherwise continuing to step 3; recording a best chromosome Z with a maximum fitness value in the iteration t;
step 4, maintaining a scale of a new generation using a roulette selection strategy:
letting m=1;
step i, calculating the fitness value of the m-th chromosome in the population
fitness(xₘ),
step ii, calculating a probability of the m-th chromosome being passed on to a next iteration as

$$p ( {x}_{m} ) = \frac{fitness ( {x}_{m} ) ,}{{\sum }_{j = 1}^{M} fitness ( {x}_{j} ) ,} ;$$

step iii, calculating a cumulative probability of m-th chromosome;

q(xₘ)=Σⱼ₌₁^{m}P(xⱼ);
step iv, generating a uniformly distributed pseudo-random number r in interval [0,1];
step v, on condition r<q₁, selecting chromosome 1, otherwise, selecting chromosome k, so that: qₖ₋₁<r≤qₖ being true;
step vi, incrementing m by one, on condition m=M, proceeding to step 5, otherwise continuing to step iv;
step 5, letting m=1; generating a random number a, for crossover rate Pt, on condition a>Pt, generating a new generation of chromosome using a two-point crossover strategy:
selecting each two individuals from the iteration t as parents each time, generating two crossover points randomly, and exchanging the integers between two crossover points of selected chromosome to obtain new chromosomes; incrementing m by one, on condition m=M/2, proceeding to step 6, otherwise continuing to step 5;
step 6, letting m=1; generating a random number b, for variation rater Pm, on condition b>Pm, generating more chromosomes for new generation based on a mutation process:
selecting two points randomly, according to a predetermined mutation probability to exchange the integers at the two points; incrementing m by one, on condition m=M, proceeding to step 7, otherwise continuing to step 7;
step 7, letting m=1; letting the population P(t+1)=P(t), replacing a first chromosome in P(t+1) with Z,
incrementing t by one, on condition t=T, proceeding to step 8, otherwise continuing to step 3;
step 8, recording the time the algorithm runs, outputting the best chromosome Z, i.e., the sequence of operations of the equipment.

Table 1 shows the source code of the genetic algorithm.

TABLE 1
the source code of the genetic algorithm

| Algorithm | Genetic algorithm | |
|---|---|---|
| Inputs | population size M, maximum iteration number T, crossover rate Pt, | |
| | variation rate Pm | |
| Variable | P(t) represents the population consisting of M chromosomes in the | |
| | interaction t, Z represents the best chromosome | |
| Output | the time the algorithm runs, the best chromosome Z, the total weighted | |
| | waiting time W | |
| | 1: | start the timing and generate the initial population P(1). |
| | 2: | t=1; |
| | 3: | while (t≤T) do |
| | 4: | for i=1 to M do |
| | 5: | calculating the fitness value of the chromosome as an |
| | inverse of following objective function for minimizing a total | |
| | weighted waiting time of the three-beam fixed cranes at the shaft | |
| | mouth, the shuttle vehicles in the deep underground passage; | |
| | 6: | end for |
| | 7: | recording the best chromosome Z with the maximum |
| | fitness value in the iteration t; | |
| | 8: | for i=1 to M do |
| | 9: | roulette operation is performed on P(t) and chromosomes |
| | with larger fitness values have a higher probability of staying; | |
| | 10: | end for |
| | 11: | for i=1 to M/2 do |
| | 11: | if random>Pt do |
| | 12: | crossover operation is performed on P(t); |
| | 13: | end if |
| | 14: | end for |
| | 15: | for i=1 to M do |
| | 16: | if random>Pm do |
| | 17: | variational operation on P(t); |
| | 18: | end if |
| | 19: | end for |
| | 20: | for i=1 to M do |
| | 21: | P(t+1)=P(t) |
| | 22: | end for |
| | 23: | replacing the first chromosome in P(t+1) with Z |
| | 24: | t=t+1 |
| | 25: | end while |
| | 26: | output the time the algorithm runs, the best chromosome Z |

Step 1 and step 2 is generating working sequences for the equipment and encoding them as a chromosome, corresponding to lines 1-2 of the pseudo code; step 3 is calculating the fitness value and recording the best chromosome Z with the maximum fitness value in the iteration t, corresponding to lines 3-7; step 4 is performing roulette operation, corresponding to lines 8-10; step 5 is performing crossover operation, corresponds to lines 11-14; step 6 is performing variational operation, corresponding to lines 15-19, step 7 is letting the population P(t+1)=P(t) and replacing the first chromosome in P(t+1) with Z, corresponding to lines 20-25; step 8 is outputting the time the algorithm runs and the best chromosome Z, corresponding to lines 26.

With access to the corresponding ground and underground working area, the deep underground passage 3 allows for the orderly transport of containers 4 from the automated container terminals 1 to the logistics parks 3, and vice versa, realizes combining the ground and underground work, also has realized the automation of the logistics park in the container terminal and effective connection between lines. The vertical loading and unloading mode of vertical well mouth can save the civil construction cost and transportation cost of ramp transportation, and effectively use space resources to save the ground zone of the automatic container terminal 1 and the logistics park. The multitude of three-beam fixed cranes fixed above the first shaft mouth and the second shaft mouth, not only can complete the operation of three containers as a group at the same time, and two trolleys in each group of beams can realize the loading and unloading at the same time, thus greatly improving the efficiency of the container loading and unloading. The multitude of three-beam fixed cranes are provided with the fixed groove, and left and right lighting device, which can realize the fixed hanging stable operation, night operation. The AGV is a surface horizontal vehicle to reduce human interference and improve the overall safety of transportation operations. The ground work area has double working lanes and driving lanes in two directions on the ground to further ensure the safety of the AGV operations. The deep underground passage has the underground work area, otherwise, the buffer can handle congestion in the underground zones, the occurrence of an emergency, vehicle maintenance needs, excess capacity, dock, and two lanes at the same time satisfy the shuttle can be employed to load and unload, turnback zone can realize the multitude of shuttle vehicles turnback, emergency lane can reduce the vehicle fault emergency situations such as congestion occurs. The deep underground passage has shuttle vehicles as horizontal transport tools, enabling long-distance transport, with three shuttle vehicles for a group to improve the volume of underground transport. The deep underground passage has a slope to avoid waterlogging at a depth of 50 meters below the terminal end, while facilitating the loading and unloading operations at the first shaft mouth and the second shaft mouth. Each slope has a buffer zone, which can be employed for accident emergency on the slope. The deep underground passage has a charging track to realize the real-time charging of the shuttle, and has drainage ditches, blind ditches, ventilation device, fire-fighting equipment, emergency communication device, and lighting device, systematically enhance the safety. The magnetic nail navigation scheme is employed to achieve the precise positioning of the multitude of the AGVs. The automatic container terminal and the logistics park is made up of the first shaft mouth and the second shaft mouth and its corresponding ground and the underground work areas, which is helpful to realize the efficient opposite transportation of shuttle vehicles in the deep underground passage. The logistics park has the no-load AGV waiting zone, which is convenient for the multitude of the AGVs to go to the designated work area after receiving the task instruction, realizing the dual transportation of the multitude of the AGVs, improving the transportation efficiency of the multitude of the AGVs and reducing the transportation cost. Each zone has distinct functions, coordinated and orderly so that the whole underground container logistics system can realize efficient, safe, unified, and orderly operation, and realize the effective connection between the automatic container terminal and the logistics park. In the description of this specification, references to the terms “one embodiment”, “embodiments”, “examples”, “concrete examples”, or “examples”, etc. mean that the specific features, structures, materials, or features described in combination with such embodiments or examples are contained in at least one embodiment or example of the present invention. In this specification, indicative representations of the above terms need not refer to the same embodiments or examples. Furthermore, the specific features, structures, materials, or features described may be combined properly in any one or more embodiments or examples. In addition, without contradiction, technicians in the field may combine and combine the different embodiments or examples described in this specification and the characteristics of the different embodiments or examples. Although embodiments of the present invention have been shown and described above, it is understood that the above embodiments are exemplary and cannot be understood as a limitation of the present invention, and ordinary technicians in the field can change, modify, replace, and modify the above embodiments within the scope of the present invention.

### REFERENCE

[1] CN patent, CN101293521, Guo Dong Jun, Yu Ming Jian, Huang Hao Hua, Yu Hao, A container transportation method, 2008 Oct. 29
[2] CN patent, CN109319515B, Chang Dao Fang, Wang Nan Xi, Gao Yin Ping, Liang Cheng Ji, Fan Yi Qun, Pan Yang, Lu Hou Jun, A port logistics park integrated with an underground logistics system, 2020 Oct. 15
[2] CN patent, CN108675156B, Gao Yin Ping, Liang Cheng Ji, Chang Dao Fang, Pan Yang, Lu Hou Jun, Luo Tian, A method for arranging an underground container logistics ground handling system, 2019 Sep. 10

What is claimed is:

1. An underground container logistics loading and unloading system based on a deep underground passage, comprising an automatic container terminal, a logistics park, and a deep underground passage; wherein:
the deep underground passage connects the automatic container terminal with the logistics park;
the deep underground passage comprises a main layout zone and an accessory equipment;
the main layout zone comprises an underground operation zone, a front buffer zone, a back buffer zone, a multitude of maintenance tracks, a first turnback zone, a second turnback zone, eight slope buffer zones, and eight slopes;
the underground operation zone is below a first shaft mouth;
the front buffer zone is at a preset distance from the underground operation zone;
the first turnback zone is located on one side of the underground operation zone;
the second turnback zone is located on one side of the underground operation zone;
the back buffer zone is located behind the first turnback zone and the second turnback zone;
the multitude of maintenance tracks are located in the back buffer zone;
the slopes are located on both sides of the deep underground passage, with four on each side;
the slope buffer zones are located at the slopes;
the accessory equipment comprises: a multitude of charging piles, a multitude of tracks, two drainage ditches, two blind ditches, a fire-fighting equipment, a ventilation device, a lighting device, and an emergency communication device;
the multitude of tracks are located on the ground of the deep underground passage;
the multitude of charging piles are located on the multitude of tracks;
the fire-fighting equipment and the emergency communication device is on the wall of the deep underground passage;
the ventilation device is located at a top of the deep underground passage;
the lighting device is located on the top of the deep underground passage;
the drainage ditches are located at both ends of the deep underground passage ground;
the blind ditches are located at both ends of the ground of the deep underground passage.

2. The underground container logistics loading and unloading system based on the deep underground passage according to claim 1, wherein the automatic container terminal comprises the first shaft mouth, a ground working area, a multitude of AGV operation lanes, a multitude of AGV running lanes, a berth, a terminal front, a terminal yard, a container freight station, a terminal parking lot;
the first shaft mouth is a node connecting the ground and the deep underground passage;
the multitude of AGV operation lanes are located on both sides of the first shaft mouth;
the multitude of AGV running lanes are located on both sides of the first shaft mouth;
a multitude of three-beam fixed cranes are located above the first shaft mouth;

3. The underground container logistics loading and unloading system based on the deep underground passage according to claim 1, wherein the logistics park comprises
the second shaft mouth, a ground operation zone, the multitude of AGV operation lanes, the multitude of AGV running lanes, a warehouse, a sorting zone, a distribution zone, a park yard, a park ground cargo loading and unloading zone, a no-load AGV waiting zone;
the second shaft mouth is located on the side of the park yard and being a vertical loading/unloading connection between the logistics park and the deep underground passage;
the multitude of AGV operation lanes are located on both sides of the second shaft mouth;
the multitude of AGV running lanes are located on both sides of the second shaft mouth;
the no-load AGV waiting zone is near the second shaft mouth;
the park yard is located near the second shaft mouth;
the warehouse is located on one side of the park ground cargo loading and unloading zone;
the sorting zone is located on one side of the warehouse;
the distribution zone is located on one side of the warehouse;
the deep underground passage is a two-way driveway.

4. The underground container logistics loading and unloading system based on the deep underground passage according to claim 2, wherein the logistics park comprises:
the second shaft mouth, a ground operation zone, the multitude of AGV operation lanes, the multitude of AGV running lanes, a warehouse, a sorting zone, a distribution zone, a park yard, a park ground cargo loading and unloading zone, a no-load AGV waiting zone;
the second shaft mouth is located on the side of the park yard and being a vertical loading/unloading connection between the logistics park and the deep underground passage;
the ground operation zone is employed to load and unload a multitude of AGVs in the second shaft mouth;
the multitude of AGV operation lanes are located on both sides of the second shaft mouth;
the multitude of AGV running lanes are located on both sides of the second shaft mouth;
the no-load AGV waiting zone is near the second shaft mouth;
the park yard is located near the second shaft mouth;
the warehouse is located on one side of the park ground cargo loading and unloading zone;
the sorting zone is located on one side of the warehouse;
the distribution zone is located on one side of the warehouse.

5. A transporting method for the underground container logistics loading and unloading system based on the deep underground passage of claim 2, comprising the following steps:
step 1, inputting a number T, letting t=1; indexing the multitude of containers from 1 to n, defining a sequence of 2n integers as a chromosome, in which the first n integers representing an index of the multitude of three-beam fixed cranes at a departure terminal assigned to handle each of the multitude of containers, and subsequent n integers representing each index of the multitude of three-beam fixed cranes at a destination terminal assigned to handle each of the multitude of containers;
step 2, for a population size M, randomly generating M chromosomes as a population P(t), wherein a m-th chromosome is noted as P(m, t);
step 3, letting m=1, decoding the m-th chromosome in the population from 1 to 2n as an operation sequence of the multitude of containers for the equipment, minimizing W as a total weighted waiting time of the multitude of three-beam fixed cranes at the first shaft mouth, the multitude of shuttle vehicles in the deep underground passage:
MinW=αΣ_{i∈D}Σ_{k∈K}Σ_{v∈V}xᵢₖᵥ(sᵢₖᵥ−tᵢ)+βΣ_{v∈V}(hᵥ−lᵥ)+γΣ_{i∈D}Σ_{k∈K}Σ_{j∈D}zᵢⱼₖ(Σ_{v∈V}sⱼₖᵥ−Σ_{v∈V}sᵢₖᵥ−T)+γΣ_{i∈D}Σ_{g∈G}Σ_{j∈D}w_{ijg}(Σ_{v∈V}o_{jgv}−Σ_{v∈V}o_{igv}−T),
wherein α, β and γ being corresponding weight parameters; D being the index of the multitude of containers to be handled, K being the index of the multitude of three-beam fixed cranes at departure terminal, G being the index of the multitude of three-beam fixed cranes at destination terminal, V being the index of the multitude of shuttle vehicles; and xᵢₖᵥ being a 0-1 variable with xᵢₖᵥ=1 if the container i being handled by the three-beam fixed crane k at the shaft mouth of the departure terminal and is loaded by the shuttle vehicle v, otherwise xᵢₖᵥ=0, sᵢₖᵥ being starting time of the three-beam fixed crane k unloading the container i from the AGV to the shuttle vehicle v at the shaft mouth of the departure terminal, tᵢ being arrival time of the AGV carried the container i, hᵥ being real leaving time of the shuttle vehicle v at the destination terminal, lᵥ being planning time of the shuttle vehicle v arriving at the shaft mouth of the departure terminal, as lᵥ=u(v−1), zᵢⱼₖ being a 0-1 variable with zᵢⱼₖ=1 if the container i and j being both handled by the three-beam fixed crane k at the departure terminal, and the container j being handled just after container i is finished, otherwise zᵢⱼₖ=0, T being processing time of handling one container by the three-beam fixed crane at the shaft mouth, w_{ijg} being a 0-1 variable with wᵢⱼₖ=1 if the container i and j being both handled by the three-beam fixed crane k at the destination terminal, and the container j being handled just after the container i is finished, otherwise w_{ijg}=0 o_{igv} being starting time of the three-beam fixed crane g unloading the container i from the shuttle vehicle v at the destination terminal;
obtaining the fitness value of each chromosome as
fitness=1/W;
incrementing m by one, on condition m=M, proceeding to step 4, otherwise proceeding to step 3; recording a best chromosome Z with a maximum fitness value in t;
step 4, maintaining a scale of a new generation using a roulette selection strategy:
letting m=1;
step i, calculating the fitness value of the m-th chromosome in the population
fitness(xₘ),
step ii, calculating a probability of the m-th chromosome being passed on to t+1-th generation chromosome as
$$p ( {x}_{m} ) = \frac{fitness ( {x}_{m} ) ,}{{\sum }_{j = 1}^{M} fitness ( {x}_{j} ) ,} ;$$
step iii, calculating a cumulative probability of the m-th chromosome;
q(xₘ)=Σⱼ₌₁^{m}P(xⱼ);
step iv, generating a uniformly distributed pseudo-random number r in interval [0,1];
step v, on condition r<q₁, selecting chromosome 1, otherwise, selecting chromosome k, so that: qₖ₋₁<r≥qₖ being true;
step vi, incrementing m by one, on condition m=M, proceeding to step 5, otherwise continuing to step iv;
step 5, letting m=1; generating a random number a, for crossover rate Pt, on condition a>Pt, generating a new generation of chromosome using a two-point crossover strategy:
selecting each two individuals from t as parents each time, generating two crossover points randomly, and exchanging the integers between two crossover points of selected chromosome to obtain new chromosomes; incrementing m by one, on condition m=M/2, proceeding to step 6, otherwise continuing to step 5;
step 6, letting m=1; generating a random number b, for variation rater Pm, on condition b>Pm, generating more chromosomes for new generation based on a mutation process:
selecting two points randomly, according to a predetermined mutation probability to exchange the integers at the two points; incrementing m by one, on condition m=M, proceeding to step 7, otherwise continuing to step 7;
step 7, letting m=1; letting the population P(t+1)=P(t), replacing a first chromosome in P(t+1) with Z,
incrementing t by one, on condition t=T, proceeding to step 8, otherwise continuing to step 3;
step 8, recording the time the algorithm runs, outputting the best chromosome Z, i.e., the sequence of operations of the containers, three-beam fixed crane and shuttle vehicles.
